(19) United States
(12) Patent Application Publication
(10) Pub. No.: US 2020/0074240 A1
(43) Pub. Date: Mar. 5, 2020

(54) Method and Apparatus for Improving Limited Sensor Estimates Using Rich Sensors

(71) Applicant: AIC Innovations Group, Inc., New York, NY (US)

(72) Inventors: Deshana Desai, Jersey City, NJ (US); Daniel Glasner, New York, NY (US)

(21) Appl. No.: 16/560,877

(22) Filed: Sep. 4, 2019

Related U.S. Application Data
(60) Provisional application No. 62/726,747, filed on Sep. 4, 2018.

(51) Int. Cl. G06K 9/62; G06N 3/08; G06N 3/04; G06K 9/00

(52) U.S. Cl. CPC G06K 9/6262; G06K 9/00315; G06N 3/04; G06N 3/08

(57) ABSTRACT

A system for improving limited sensor estimates using rich sensor estimates is described. The system includes one or more computers and one or more storage devices storing instructions that, when executed by one or more computers, cause the one or more computers to perform operations including: performing the following steps at least once: receiving rich sensor data, captured by a high-resolution sensor, of an input scene; receiving limited sensor data, captured by a low-resolution sensor, of the input scene; processing the rich sensor data using a first estimator to generate a first estimate that represents a first set of characteristics of the input scene; processing the limited sensor data using a second estimator to generate a second estimate in accordance with current values of parameters of the second estimator, the second estimate representing a second set of characteristics of the input scene, the second estimator being a deep neural network; determining a loss function that represents a difference in quality between the first estimate and the second estimate; and training the second estimator by adjusting the current values of the parameters of the second estimator to minimize the loss function. The operations further include: obtaining new limited sensor data, captured by the low-resolution sensor, of a new input scene; and processing the new limited sensor data using the trained second estimator in accordance with the adjusted values of parameters of the second estimator to generate a new estimate that represents a new set of characteristics of the new input scene.

### CROSS REFERENCE TO RELATED APPLICATIONS

This application claims the benefit of U.S. Provisional Patent Application No. 62/726,747 filed Sep. 4, 2018 to Daniel Glasner, et al., titled “Method and Apparatus for Improving Limited Sensor Estimates Using Rich Sensors”, the contents thereof being incorporated herein by reference.

### FIELD

This is directed generally to the field of image processing, and particularly to the use of high-resolution sensors to train a computer vision or other neural network system, and then use lower resolution sensors to collect data to be interpreted using the trained system. The inventive solution may also be applied to any signal processing domain, such as audio processing and the like. The inventive solution may also be used across modalities, including but not limited to using estimates made with a depth sensor to improve estimates made with an RGB sensor and using estimates made with an infrared sensor to improve estimates made with an RGB sensor.

### BACKGROUND

Use of computer vision systems in particular, and neural network system in general, typically require a large amount of training data and a sophisticated computer processing system to not only train the system, but also to process input data. Such requirements have limited the use of such networks to larger systems with high resolution sensors collecting high resolution data.

Therefore, it would be beneficial to provide an improved process that overcomes these drawbacks of the prior art.

### SUMMARY

The subject matter described in this disclosure relates to a system that uses sensor readings from high-resolution sensors to train an estimator, allowing for data collected from low-resolution sensor to be processed by the trained estimator. As such, the system can benefit from the use of more sophisticated computer vision solutions even when working with lower-resolution sensors and less powerful processing systems.

In accordance with embodiments of the disclosure, the goal is to estimate some quantity from the environment given inputs from a low-resolution sensor. A lower-resolution sensor (for example, a sensor included in a portable device such as a camera of a mobile phone) may be limited with respect to resolution, dynamic range, or may have other impedances to collecting high quality data. In order to improve the quality of the collected information, a large dataset of rich/high quality measurements is collected by a high-resolution sensor and relied upon as a ground truth. Reliable estimates are calculated and used as supervision to train an estimator which can then be used with the lower-quality and resolution sensors. A high-resolution sensor can be, for example, a RGB-D (color and depth) sensor that provides high-resolution RGB images of a scene and depth information of the scene.

In an embodiment, the subject matter described in this disclosure may be applicable to measuring, for example, facial action units from the face of a user by using an estimator that is trained using facial action unit estimates from rich RGB-D sensors (e.g., estimates that provides RGB and depth information) to improve estimates generated by the system based upon information collected from lower quality RGB sensors (which do not include any depth information). This could allow for one to analyze, for example patient or other user behavior using the lower quality, more ubiquitous, lower quality sensors. This would allow the use of any such system to be cheaper and more easily distributable. The collection of this information may further allow for the analysis of facial analytics using the Action Unit estimates.

In accordance with one or more embodiments of the present disclosure, the RGB-D sensor estimates serve as a bottleneck for the RGB sensor estimates. This means it is important to be able to trust the RGB-D sensor estimates as being sufficiently accurate. Once this is confirmed, the problem reduces to a goal of finding the best system and method that minimizes any delta between any estimates produced by the RGB-D and RGB sensors.

One innovative aspect of the subject matter descried in this disclosure can be embodied in a system that includes one or more computers and one or more storage devices storing instructions that, when executed by the one or more computers, cause the one or more computers to perform operations including: performing the following steps at least once: receiving rich sensor data, captured by a high-resolution sensor, of an input scene; receiving limited sensor data, captured by a low-resolution sensor, of the input scene; processing the rich sensor data using a first estimator to generate a first estimate that represents a first set of characteristics of the input scene; processing the limited sensor data using a second estimator to generate a second estimate in accordance with current values of parameters of the second estimator, the second estimate representing a second set of characteristics of the input scene, the second estimator being a deep neural network; determining a loss function that represents a difference in quality between the first estimate and the second estimate; and training the second estimator by adjusting the current values of the parameters of the second estimator to minimize the loss function. The operations further include obtaining new limited sensor data, captured by the low-resolution sensor, of a new input scene; and processing the new limited sensor data using the trained second estimator in accordance with the adjusted values of parameters of the second estimator to generate a new estimate that represents a new set of characteristics of the new input scene.

The foregoing and other embodiments can each optionally include one or more of the following features, alone or in combination. The operations may include repeatedly performing the steps to adjust the current values of parameters of the second estimator until the loss function is less than a predetermined threshold. The rich sensor data may include high-resolution RGB images of the input scene and corresponding depth maps of the high-resolution RGB images. The limited sensor data may include low-resolution RGB images of the input scene. The low-resolution sensor may be a camera of a portable device. The deep neural network may include one or more convolutional neural network layers followed by one or more fully connected neural network layers followed by a sigmoid activation neural network layer. The input scene may be a face of a user. In some cases, the first estimate and the second estimate may include estimated facial action units of the user's face, wherein a facial action unit represents an action of one or more muscles of the user's face and identifies a facial expression of the user. In some other cases, the first estimate and the second estimate comprise estimated blendshapes of the user's face.

Other innovative aspects of the subject matter described in this specification can be embodied in a computer-implemented method and one or more non-transitory storage media encoded with instructions that when implemented by one or more computers cause the one or more computers to perform the operations described above.

Another innovative aspect of the subject matter described in this specification can be embodied in a computer-implemented method comprising: performing, using one or more computers of a first system, the following steps at least once: receiving rich sensor data, captured by a high-resolution sensor, of an input scene; receiving limited sensor data, captured by a low-resolution sensor, of the input scene; processing the rich sensor data using a first estimator to generate a first estimate that represents a first set of characteristics of the input scene; processing the limited sensor data using a second estimator to generate a second estimate in accordance with current values of parameters of the second estimator, the second estimate representing a second set of characteristics of the input scene, the second estimator being a deep neural network; determining a loss function that represents a difference in quality between the first estimate and the second estimate; and training the second estimator by adjusting the current values of the parameters of the second estimator to minimize the loss function. The method further includes: providing the trained second estimator to a second system, wherein the second computing system is configured to process new limited sensor data of a new input scene using the trained second estimator to generate a new estimate that represents a new set of characteristics of the new input scene.

Still other objects and advantages of the subject matter described in this disclosure will in part be obvious and will in part be apparent from the specification and drawings.

The disclosure accordingly comprises the several steps and the relation of one or more of such steps with respect to each of the others, and the apparatus embodying features of construction, combinations of elements and arrangement of parts that are adapted to affect such steps, all as exemplified in the following detailed disclosure, and the scope of the subject matter described in this disclosure will be indicated in the claims.

### BRIEF DESCRIPTION OF THE DRAWINGS

For a more complete understanding of the subject matter described in this disclosure, reference is made to the following description and accompanying drawings, in which:

FIG. 1 depicts a data capture and transfer system constructed in accordance with an embodiment of the subject matter described in this disclosure;

FIG. 2 depicts a remote information capture apparatus constructed in accordance with an embodiment of the subject matter described in this disclosure;

FIG. 3 is a process diagram depicting a problem set up in accordance with an embodiment of the subject matter described in this disclosure;

FIG. 4 is a process diagram depicting a training of a system constructed in accordance with an embodiment of the subject matter described in this disclosure;

FIG. 5 is a process diagram depicting use of limited sensors based upon the system trained with respect to FIG. 4 in accordance with an embodiment of the subject matter described in this disclosure;

FIG. 6 is a relational diagram depicting a relationship between low and high resolution sensors in accordance with an embodiment of the subject matter described in this disclosure;

FIG. 7 is a process diagram depicting an alternative embodiment of the training process described in FIG. 4 in accordance with an alternative embodiment of the subject matter described in this disclosure;

FIG. 8 is a process diagram depicting use of a training and processing system employing both low and high resolution sensors in accordance with an embodiment of the subject matter described in this disclosure;

FIG. 9 depicts a setup for acquiring data employing the low and high resolution sensors in accordance with an embodiment of the subject matter described in this disclosure;

FIG. 10 depicts visualizations corresponding to a heat map depicting correlations between activation of various face activations and video sequences provided within a boxplot graph depicting overall activation in the collected videos in accordance with an embodiment of the subject matter described in this disclosure;

FIG. 11 depicts visualizations corresponding to a groundtruth of activations, images of one type of action performed by users, and a resulting overall movement for each of a plurality of different actions;

FIG. 12 depicts a system for differentiating micro-expressions using action units as applied in accordance with an embodiment of the subject matter described in this disclosure;

FIG. 13 depicts an emotional facial action coding system as applied in accordance with an embodiment of the subject matter described in this disclosure;

FIG. 14 depicts a graph showing L1 and L2 losses on test sets in accordance with application of an embodiment of the subject matter described in this disclosure;

FIGS. 15a and 15b depict results from precision recall for each action unit from phases 1 and 2 respectively in accordance with application of an embodiment of the subject matter described in this disclosure;

FIGS. 16A and 16B depict scatter plot graphs showing a relationship between the a distribution and a predicted distribution for phases 1 and 2 respectively in accordance with application of an embodiment of the subject matter described in this disclosure;

FIGS. 16C and 16D depict scatter plots showing a relationship between precision-recall values with the size of a marker proportional and the number of activations in the training data available for a particular action unit for phases 1 and 2 respectively in accordance with application of an embodiment of the subject matter described in this disclosure; and

FIG. 17 depicts a boxplot showing Expressivity Scores for a “rest face” for different people.

### DETAILED DESCRIPTION

Referring to the following images embodiments of the subject matter described in this disclosure will now be described.

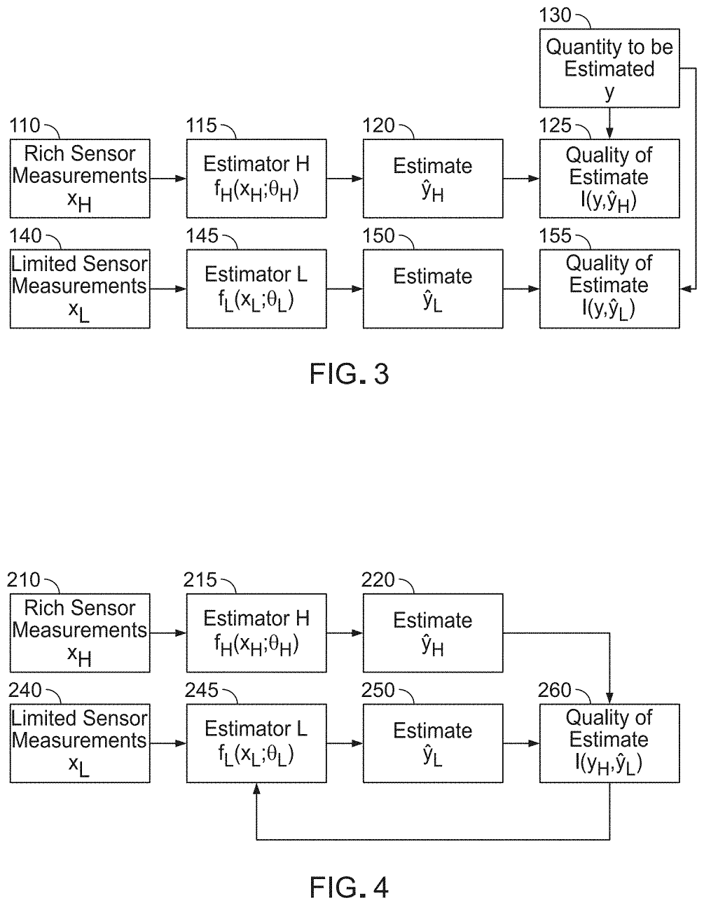

FIG. 3 illustrate the problem that is being addressed by the subject matter described in the present disclosure. As shown in FIG. 3, assuming that estimator H operating on rich sensor measurements (e.g., measurements provided by a RGB-D sensor) provides an estimate that is sufficiently close to a quantity to be estimated, this estimate produced by estimator H can be considered as a ground truth. Therefore, the goal of one or more embodiments of the present disclosure is to improve the estimate provided by estimator L operating on limited sensor measurements (e.g., measurements provided by a RGB sensor) until the delta (i.e., the difference) between the estimates provided by the estimators H and L is acceptable small, e.g., the delta is less than a predetermined threshold value.

A rich sensor measurement is taken by a rich sensor (also referred to as a high-resolution sensor or a RGB-D sensor) from a scene at step 110. At step 115, an estimator H is employed to process the rich sensor measurement to generate an estimate of H at step 120. Similarly, a limited sensor measurement is taken by a limited sensor (also referred to as a low-resolution sensor) from the same scene at step 140, and at step 145 an estimator L is employed to generate an estimate of L at step 150. Then, a quantity to be estimated (e.g., ground truth y) at step 130 is compared to the H estimate at step 125, and the L estimate at step 155. The L estimate is determined to be acceptable once the delta between the L estimate and H estimate as compared to the ground truth is below a predetermined threshold. An example method and system for implementing this process will be described in more detail below. The process can be further improved by employing machine learning.

A rich sensor can be, for example, a RGB-D sensor that provides high-resolution RGB images and depth maps of the images, while a limited sensor can be, for example, a RGB sensor that provides only RGB images (without depth information). As another example, a rich sensor can be a sensor with color and thermal information. A limited sensor can be a sensor with only thermal information.

FIG. 4 illustrates an example process for training the system including an estimator H and an estimator L. Rich sensor measurements are made on an input scene at step 210 and provided to the estimator H at step 215. The estimator H processes the rich sensor measurements to generate an estimate H in accordance with current values of parameters θ_{H} of the estimator H at step 220. Limited sensor measurements are made at step 240 on the same input scene and are provided to an estimator L at step 245. The estimator L processes the limited sensor measurements in accordance with current values of parameters θ_{L} of the estimator L to generate an estimate L at step 250. An empirical loss/that represents a difference in quality between the estimate L and the estimate H is determined at step 260. The empirical loss is used to adjust current values of parameters of the estimator L at step 245 in order to improve the quality of estimator L. For example, the empirical loss can be a Mean Square Error loss. The process can include backpropagating a gradient of the empirical loss to update the values of parameters of the estimator L to minimize the empirical loss.

The above training process may continue until a sufficient small empirical loss is achieved. That is, the process may continue updating values of parameters of the estimator L until the empirical loss representing a difference in quality between the estimate L and estimate H is less than a predetermined threshold. In some implementations, the process may be performed based upon the provided input scene. In some other implementations, the above training process may be performed based upon the processing of multiple scenes.

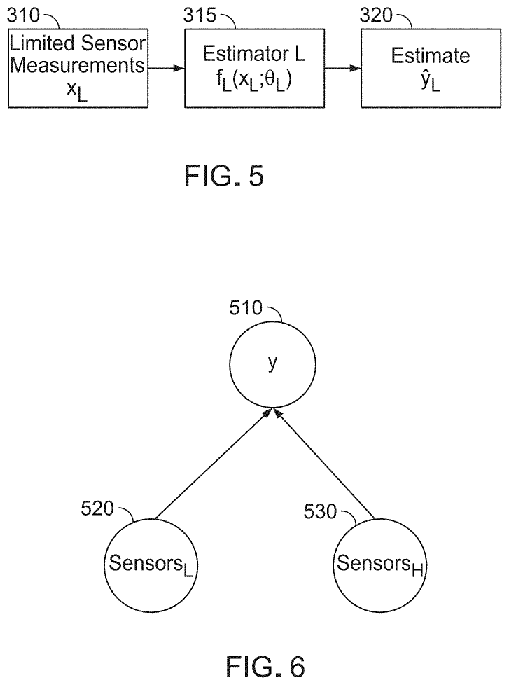

Referring next to FIG. 5, once the system has been sufficiently trained (i.e., when sensor estimates generated by the estimator L from limited sensor measurements are sufficiently close to the estimates generated by the estimator H from rich sensor measurements), the system may process new limited sensor measurements using the trained estimator L to generate one or more corresponding estimates in accordance with adjusted values of parameters of the trained estimator L. As the estimator L have been trained using training techniques described above with reference to FIG. 4, the estimates generated by the estimator L can be sufficiently close to the estimates that would have been produced by the estimator H from rich sensor measurements taken from the same scene. In the example of FIG. 5, new limited sensor measurements is taken from an input scene at step 310, the trained estimator L is applied at step 315, and the estimate of L is outputted at step 320. In some scenarios, the performance of the system can be improved (e.g. the system provides better results) when a correlation between the rich and limited sensor measurements are identified. Therefore, it is important to identify, during the learning process employed when training the system using the rich sensor data, patterns presented in the rich sensor data that are correlated to, and therefore indicative of, patterns that will be present in the limited sensor data.

This situation may exist in a number of scenarios:

sensors_{L}⊆sensors_{H},

sensors_{L}∩sensors_{H}≠Ø,

sensors_{L}∩sensors_{H}=Ø,

where sensors_L are the limited set of sensors and sensors_H are the rich set of sensors. Thus, in the first two scenarios, where the sensors_L are a subset of the sensors_H and where there is some overlap between the sensors_L and the sensors_H are likely to provide the best results. Even in the third, where there is no overlap between the sets of sensors, it may be possible to learn an improved estimate when there exists correlation between sensors_L (520) and y (510) and correlation between sensors_H (530) and y (510) (as shown in FIG. 6).

The system may also be most useful when the ground truth is hard to get, because if the ground truth is evident, comparisons between the sensors_L and the ground truth may be directly performed.

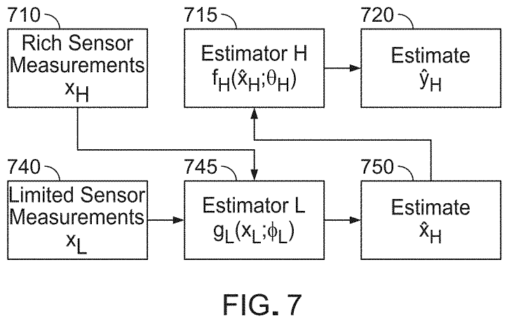

An alternative embodiment of the subject matter described in this disclosure is depicted in FIG. 7, in which rich sensor measurements 710 and limited sensor measurements 740 are directly provided to estimator L 745, which is trained to produce an estimate of the signal measured by the rich sensor 710 (estimate \hat{x}_{H}). This estimate \hat{x}_{H} may then be provided to estimator H 715, to produce an estimate of the quantity of interest y 720. An optional subsequent step would be to adjust the parameters of the estimator H 715 to estimate 750 from estimator L 745. This would involve fine-tuning the parameters θ_{H} to minimize the difference between estimates ŷ_{\hat{x}}_{_{H}} and y. A final alternative is joint optimization where the parameters of the two estimators are jointly trained to minimize two loss terms. One that penalizes the difference between estimates \hat{x}_{H} and rich sensor measurements x_{H} the other which penalized the difference between estimates ŷ_{\hat{x}}_{_{H}} and y. A parameter └ preferably defines the relative importance of these two loss terms. It's value is set by optimizing performance on a validation set.

The benefits of the prior discriminative embodiment to this alternative embodiment of the subject matter described in this disclosure include:

1. Fewer parameters need to be estimated;

2. There is no cumulative error generated when processing the data; and

3. Estimator H in this model may not be robust to noise between the two estimates H.

Applications of the various embodiments of the subject matter described in this disclosure include using the system for estimating blendshapes or Action Units (as known in the art as units defining one or more facial muscle movements) from RGB data. An action unit includes a group of muscle movements. In particular, points on the face are measured, and the movement of one or a combination of the points are indicative of movement of a facial group, and thus an expression. A blendshape is a dictionary of named coefficients representing the detected facial expression in terms of the movement of specific facial features. Thus, it is a dictionary with the detected specific facial action unit such as “left eye brow raised” with the corresponding value ranging from 0.0 to 1.0 with 1.0 referring to maximum movement and 0.0 referring to neutral.

As noted above, the RGB-D data would provide “supervision” to the RGB data. This would be an example of a situation where the RGB data was a subset of the RGB-D data. The subject matter described in this disclosure is useful in this situation as blendshapes and action units are very hard to estimate and human annotation of these images can be very subjective. Depth measurements (the “D” in RGB-D) are typically far more accurate and objective.

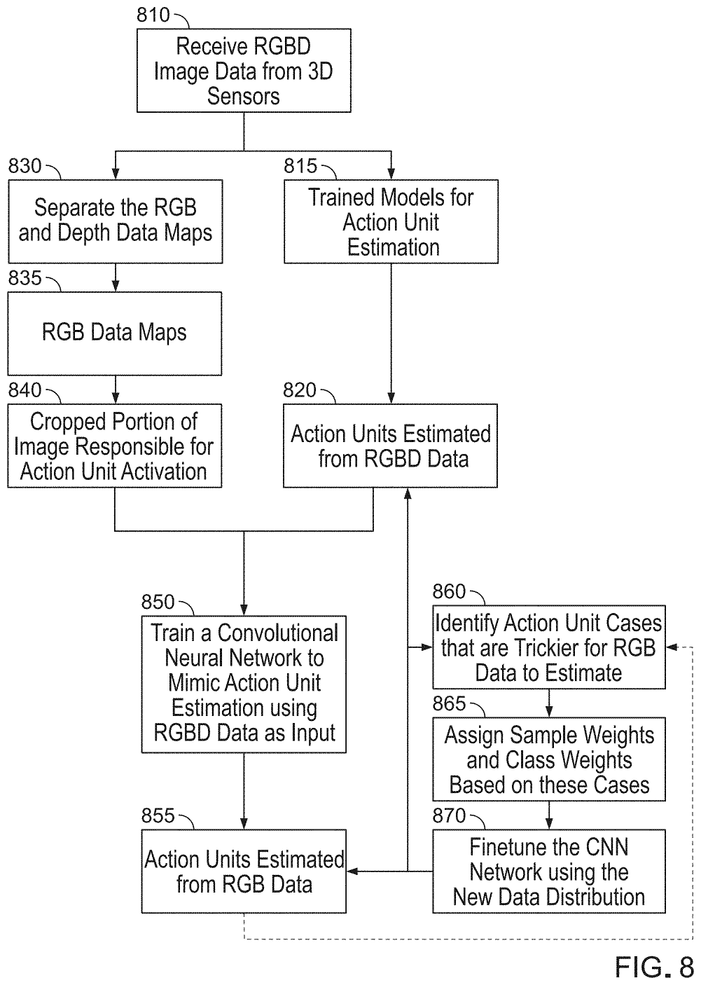

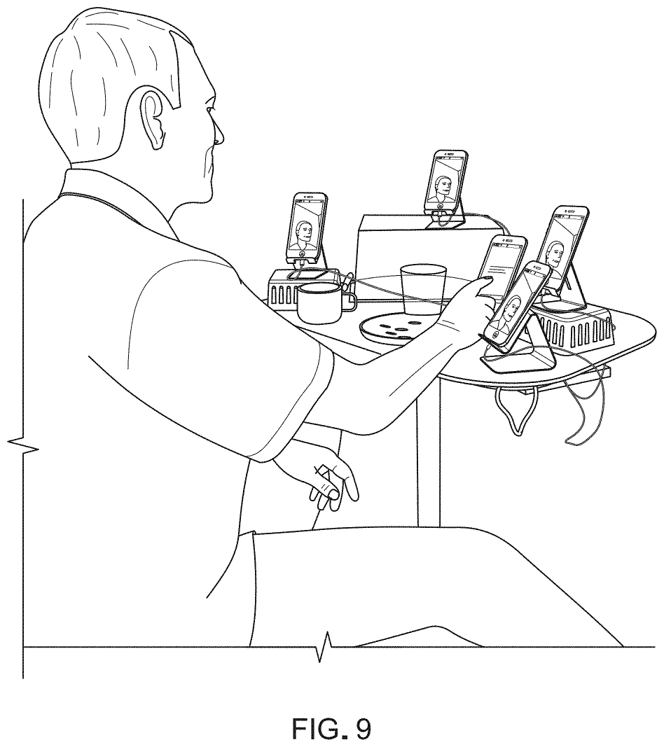

An example of use of the system in such a manner in accordance with an embodiment of the subject matter described in this disclosure is shown in FIG. 8. As is shown, at step 810, RGB-D image data including RGB images and corresponding depth maps is received from one or more 3D sensors. A depth map includes predicted depth value for each pixel of multiple pixels in a given image, e.g., for all of the pixels or some predetermined proper subset of the pixels. The depth value of a pixel is a representation of a perpendicular distance between (i) a plane in which the given image is recorded, and (ii) a scene depicted at the pixel. On the right side of the chart in step 815, this data is used to train models for Action Unit estimation, and at step 820 Action Units are estimated from the RGB-D data. In parallel, the RGB data and the depth maps are separated at step 830, and RGB data map is generated at step 835, is applied to a cropped portion of the acquired image responsible for Activation Unit activation at step 840. Processing then continues at step 850 where these two sets of output data are then used to train a Convolutional Neural Network to mimic the Action Unit estimation using the RGB data as an input. The Convolutional Neural Network includes one or more convolutional neural network layers. Thereafter, Action Units are estimated from the RGB data at step 855, and fed back to assist the training process to step 820 where the Action Units are estimated from the RGB-D data, and well as assisting in identifying one or more Action Unit cases at step 865 that are trickier for the RGB data to properly estimate. Sample weights and class weights may be assigned based upon these cases, the Neural Network may be retrained using these new data distributions in addition to simply using the estimate RGB Action Unit estimates at step 870, and processing continues back at steps 820 and 860. As shown in FIG. 9, the capture process includes using a variety of blendshape activations, both extreme and subtle, providing various stimuli to a subject, and viewing the collected images from multiple viewpoints.

A second preferred application of the present subject matter may include detecting and segmenting humans in photos and videos from RGB data. In this scenario, it is possible to use infrared (IR) data as the supervisory data, instead of the RGB-D data. In this scenario, there is in fact no intersection of the sensors between the two groups of sensors, but a satisfactory result may be nonetheless produced. Humans are easy to detect and segment in IR imagery, while manually segmenting and detecting humans from an RGB image can be difficult and tedious. In accordance with this alternative embodiment of the subject matter described in this disclosure, both IR and RGB data are simultaneously captured of an image, and these two modalities are registered.

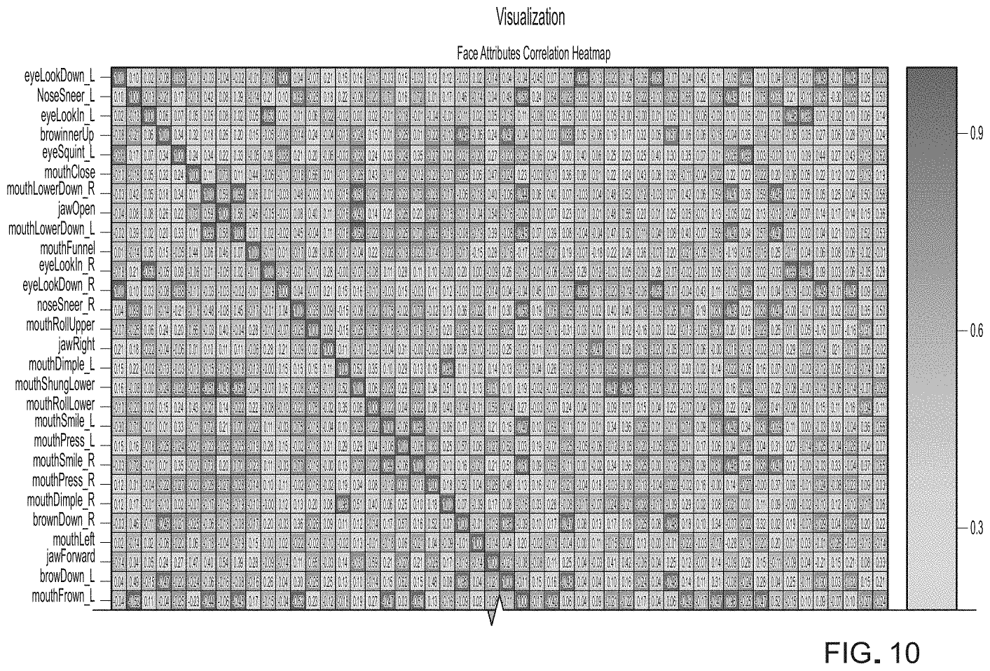

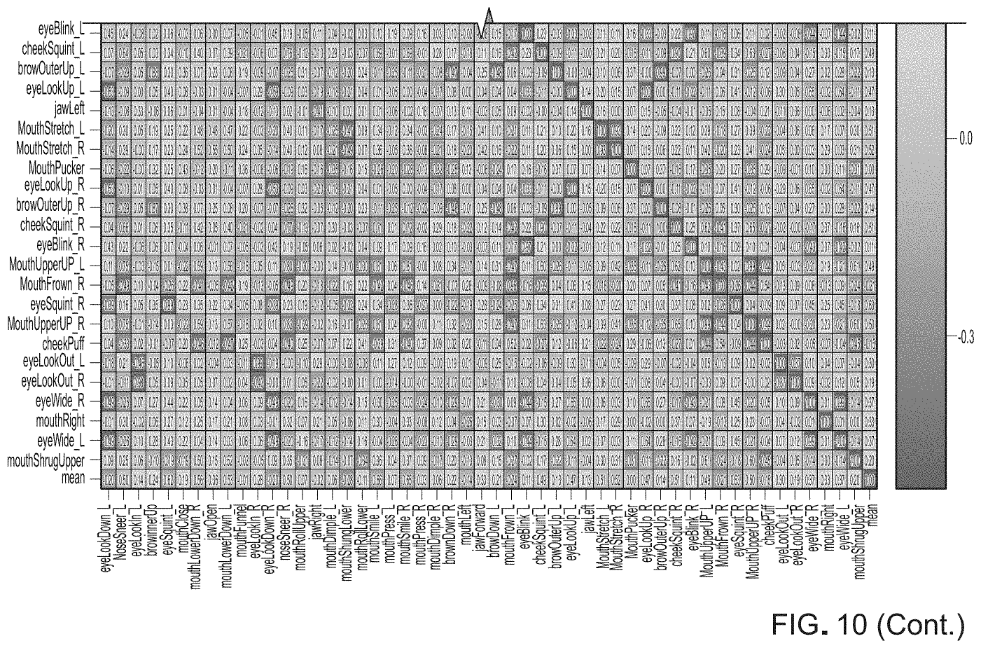

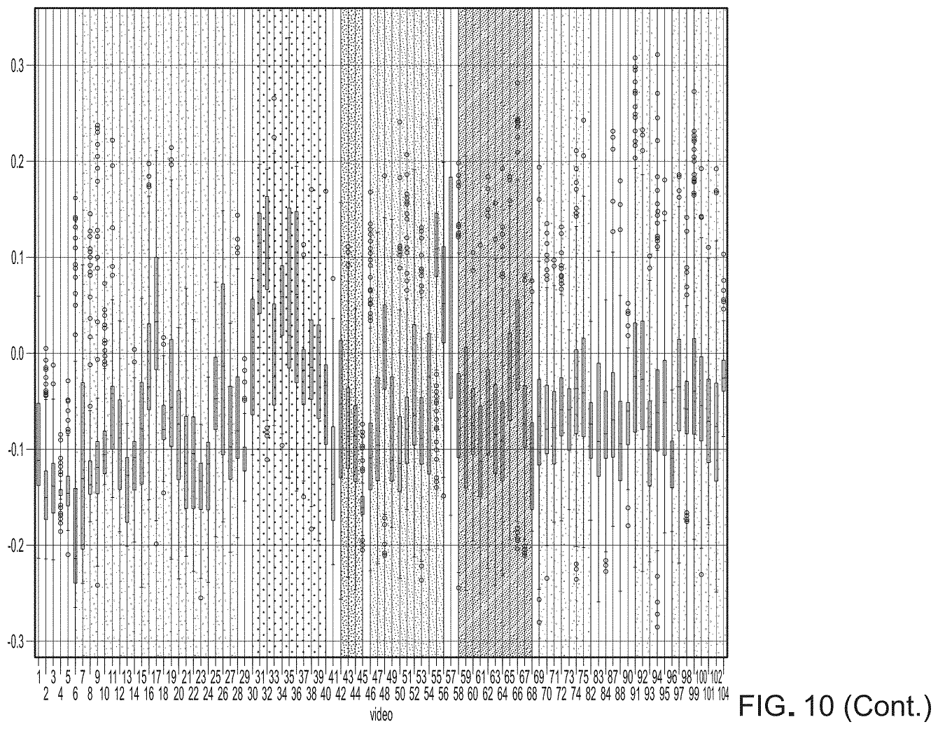

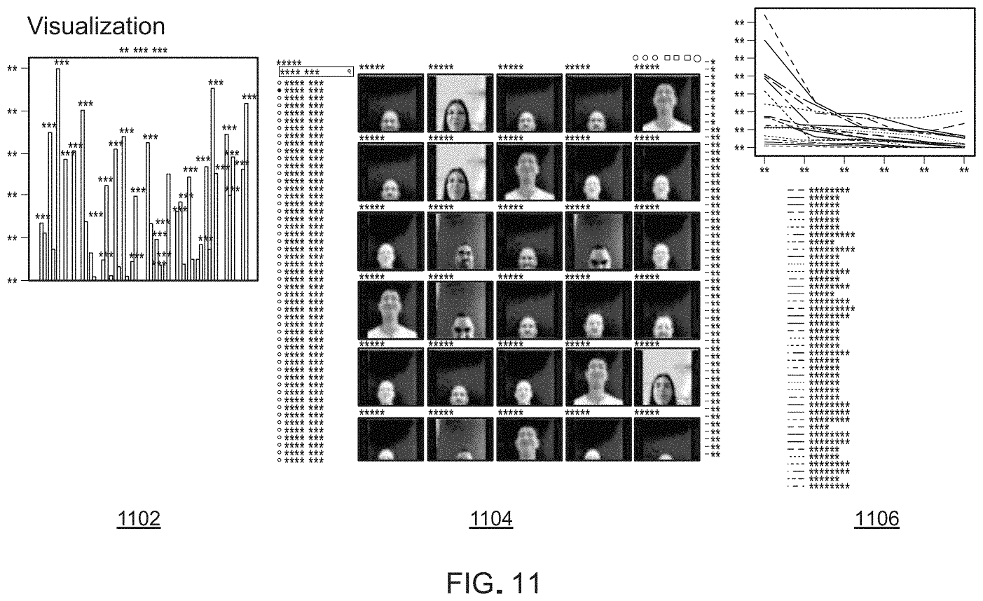

The following visualizations may be possible from the collected data as shown in FIGS. 10 and 11.

1. A heat map depicting correlations between activation of various face activations (1010);

For each facial action unit, a heatmap of correlations of the activation values is determined. For example, if a person is smiling, it is likely that the “lips corner puller” and “cheek puffed” are both activated. These action units are not independent of each other. These correlations are used to tweak our loss function and guide the model to learn the estimates quicker.

2. Video sequences provided within a boxplot graph depicting overall activation in the collected videos (1020);

The above mentioned IMA (Intelligent Medical Assistant) is used to guide the user/subject through a number of questions and exercises. The plot is a box plot (as covered above) for one person. The x-axis in this plot is the time. During different activities, the user/subject had different median expressivity levels. This is used to figure out which activities were on an average leading to more expressivity (or engagement with the tool) than others.

3. The groundtruth of activations (what actually happened) (1102);

The plots show, for each action unit, scores for individuals are from 0.0 to 1.0. The scores are turned into a binary classifier. A score of >0.3 was considered as “action unit is activated”. The leftmost plot shows the distribution of different action units activations in the groundtruth, i.e. the rich sensor estimates. The middle plot simply shows an example of the different participants performing an action upon request as recorded by us in grayscale.

4. Images of one type of action performed by users (1104); and
5. Resulting overall movement for each of a plurality of different actions (1106).

### Action Units

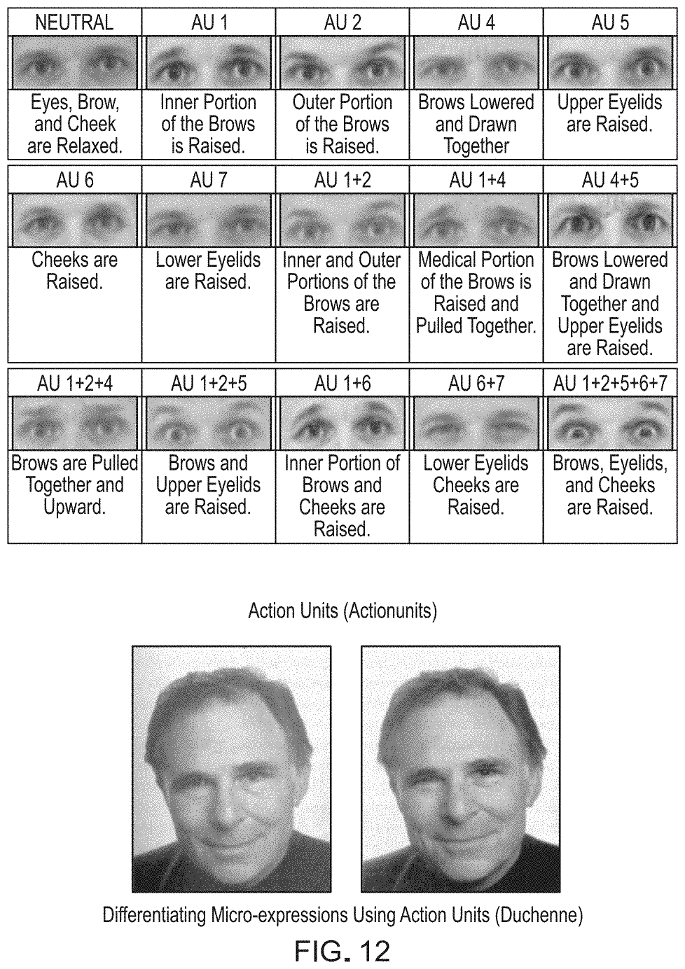

Action units (as referenced above) are fundamental actions of individual muscles or groups of muscles. The Facial Action Coding System adopted by Ekman et al. (originally inspired by a system developed by Carl-Herman Hjortsjö records 98 Action Units. Out of these there are Action Unit estimates for approximately 35 Action Units with increased granularity. The state-of-the-art AU prediction technology developed by OpenFace records about 17 of them (See FIG. 12, for example). The reason why the Facial Action Coding System (FACS) is powerful is that using FACS, human coders can manually code nearly any anatomically possible facial expression, deconstructing it into specific Action Units and their temporal segments that produced the expression. Thus FACS is a system to taxonomize human facial movements by their appearance on the face.

An example to illustrate the subtle expressions that can be captured by AUs is as follows: One can differentiate between two types of smiles: The Pan American Smile and The Duchenne Smile. The Pan American Smile is insincere and voluntary. It is produced by the contraction of the zygomatic major alone. The Duchenne Smile on the other hand, is sincere and involuntary. It is produced by not only the contraction of the Zygomatic Major but also the inferior part of the Orbicularis Oculi. Using Action units, one can make this kind of distinction.

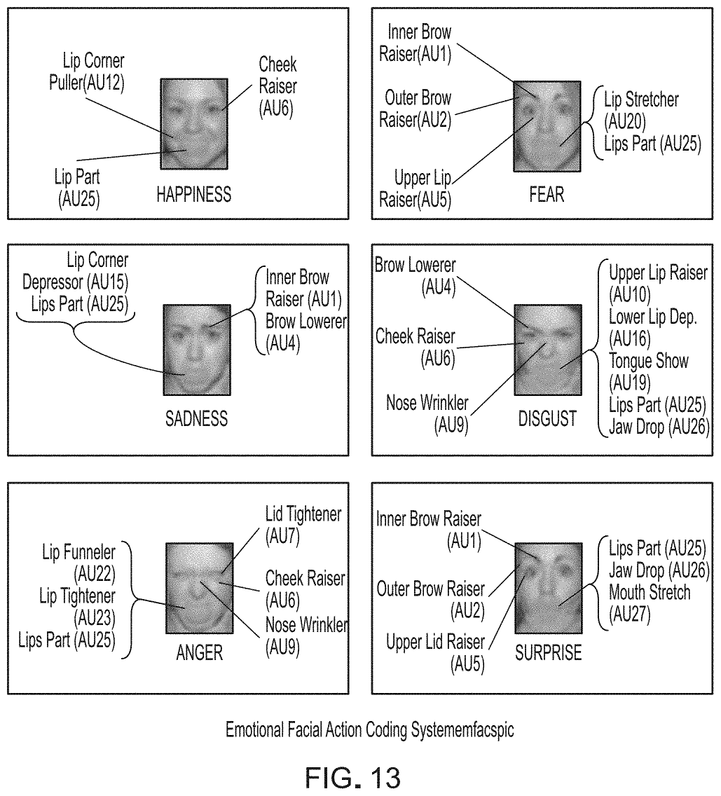

Finally, a modification of the FACS is EMFACS (Emotional Facial Action Coding System). The EMFACS (see FIG. 13) considers only emotion-related facial action units. This way, one can use information on detected action units to determine which of the action units were activated. This can help identify different kinds of emotions.

### Data Collection—Example

In accordance with the use of an embodiment of the present disclosure, one may collect data from the RGB-D sensors for Action Unit Estimation using RGB sensors. In the current example employed by the present disclosure, there were two phases of data collection. In Phase 1, approximately 0.2 million face data points were collected using RGB-D sensors and corresponding action unit estimates. This was done over a period of 3 hours in a constrained environment. The setting encouraged producing different facial actions.

In Phase 2, a data collection experiment was performed with approximately 25 data subjects, resulting in approximately 1 million data points (collected from a primary device). The data subjects were asked to sit in a room of varied lighting conditions and backdrops. There were 4 devices recording them from different angles. These 4 devices operated a minimalist software application that simply recorded the data and ran the algorithm to compute accurate action unit estimates. The primary device that the data subject interacted with ran a software application that was programmed to be interactive and engage the data subject in an array of expressive exercises.

A questionnaire that took about 20 minutes to complete was presented to each data subject. The questionnaire provided audio as well as textual (and optionally illustrative) guides for each instruction. The questionnaire employed in accordance with the present disclosure began with Motion Exercises which involved exercises related to the movement of the head, eye and mouth. For example—“funnel your mouth as shown in the illustration”, “Please tilt your head such that your left ear reaches towards your left shoulder.” Some of the motion exercises were harder to follow and therefore included illustrations of the movement which the participant had to imitate. Followed by this, FEE (Facial Expressivity Exercises) were employed which instructed the data subjects to show faces with different manufactured emotions. For example, “Please make a happy face” or “Please make a very happy face for me.” This exercise captured different intensities of participants displaying happiness, sadness, anger, fear and disgust. Finally, they were asked to make the most expressive face they could. The next exercise was the Expressive Reading Test. In this exercise, data subjects were asked to theatrically enact some passages from the poem ‘The Rime of the Ancient Mariner’. These passages were chosen due to their evocative elements as mentioned in literature. After the Expressive Reading Test, the data subjects were led through a Cheating test. In this exercise, data subjects imitated a patient cheating when taking medication while using a system provided by AiCure, LLC for automatically monitoring proper dosing of medication. Specific instructions were provided asking the data subjects to cheat in particular ways that patients are most likely to cheat in. The next exercise was a VST (Visual Stimulus Test) where data subjects were shown a series of ten images and asked to talk about how they felt or what it reminded them of when they saw these images. The images varied in expectation of reaction to stimulus being happiness or warmth to sympathy to fear, hatred or disgust. The final exercise in the questionnaire flow was the ANSA which included questions taken from standard psychology procedures generally used by doctors/specialists when examining mental health patients. This was imitated by an Artificially Intelligent Medical Assistant which asked data subjects questions and followed a flow of questions that was adapted to the answers given by the data subjects.

In particular, ANSA stands for “Adult Needs and Strengths Assessment.” It is a commonly used tool in psychiatry. In this tool, the service provider asks a set of questions to the user related to Life Domain Functioning (Family, employment etc.), Behavioural Health Needs, Risk behaviours etc. and each of these dimensions is then rated on a 4-point scale after the interview. Following this rating, decisions are taken including the development of specific algorithms for levels of care including psychiatric hospitalization, community services, etc. The ANSA is an effective assessment tool for used in either the development of individual plans of care or for use in designing and planning systems of care for adults with behavioral health (mental health or substance use) challenges.

The tool is replicated and employed to implements embodiments described in this disclosure. However, instead of having an individual interview a user, an automated (smart) software tool called the IMA (Intelligent Medical Assistant) is used to interview the user.

At the end of this experiment, each of the data subjects were asked to take the Berkeley Expressivity Questionnaire. The questionnaire consists of a series of questions where the data subjects are asked to rate themselves on a likert scale of 1-7. The cumulative scores would give a quantitative measure of a person's emotional expressivity.

Training Experiments

Deep Learning Frameworks such as Keras and Tensorflow (as well known to one of ordinary skill in the art) are employed. The data handling, cleaning and processing are performed with Python and corresponding libraries, but may be deployed with any appropriate computing language and libraries.

In accordance with embodiments of the present disclosure, several processes are employed to train an estimator which is a deep neural network to estimate facial action units using action unit estimates from the RGB-D data as groundtruth. The RGB image and depth maps may be separated first. Next, the RGB image may be taken and run through a state-of-the-art MTCNN Face Detection algorithm. This produces a cropped and aligned face from the original image.

This reduces the source of errors as the background is removed from the image before feeding it as input to the deep neural network to be trained. The final preparatory step is to process the image by normalizing it and resizing it. This image is now fed as input to the deep neural network. In some implementations, the deep neural network includes one or more convolutional neural network layers followed by one or more fully connected neural network layers. In some implementations, the deep neural network may include other kinds of layers such as max pooling and activation neural network layers. In some implementations, in a final fully connected layer of the network, there are 51 continuous outputs between 0-1 corresponding to the 51 units to be estimated. The fully connected layer may be followed by a sigmoid activation function in all the experiments to limit the outputs between 0-1. A 0.0 activation of a class may be interpreted to mean there is no movement seen for that unit, while a 1.0 activation of a class may be interpreted to mean there is maximum movement seen for that unit. Mean Square Error loss may be employed as the loss function to train the deep neural network.

A first phase of experiments revolved around size, initializations and hyper-parameter testing. Various different networks of varying size from custom architectures were tested with 7 layers to architectures with 50 layers such as ResNet. The MSE loss was the architecture with 7 layers resulted in an error of 0.03 (and validation loss of 0.02\%) when trained for 20 epochs while the 50 layer network resulted in an error of 0.002 (and validation loss of 0.003) with the chosen best hyper-parameter settings. The Mean Absolute Error decreased from about 0.1 to 0.03 by using the larger network. (The differences between the network architectures were not limited to size). Initialization with ImageNet performed consistently better with a large head start in the error reduction from epoch 1 itself as compared to random initializations.

A novel technique was tried which led to faster convergence towards the least error rate was using second order statistics to guide the network in its decision making behavior. While the final fully connected layer outputs 51 action units, some of these classes are highly correlated with others. For example, if the left eyebrow is raised for a person, there is a high likelihood that the right eyebrow is also raised. Similarly, if the left part of the mouth is curled upwards (for instance, when smiling), it increases the likelihood that cheek is puffed. To incorporate this distributional information into the network, instead of penalizing the difference between second order statistic information in the predicted distribution and the ground-truth distribution, the loss function was modified from MSE Loss to add a weighted term for penalizing the difference between the weight matrices of each neuron proportional to the correlation between the two given classes.

$$L = \frac{{\sum }_{i = 1}^{n} {( {y}_{i} - {\hat{y}}_{i} )}^{2}}{n} + λ {\sum }_{( i , j ) i \neq j} {r}_{ij} \sqrt{{\sum }_{k} {( {w}_{{i}_{k}} - {w}_{{j}_{k}} )}^{2}}$$

The lambda term is the co-efficient to distribute weight to the correlation-based-penalization term in the loss function. After a quick hyper-parameter search, it was set to 0.01. rᵢⱼ refers to the value in the Pearson correlation co-efficient between action unit i and action unit j. This value was computed beforehand based on the ground truth distribution. wᵢ_{ₖ} refers to the weight for a neuron i in the last FC layer as multiplied with an output from a neuron j in the penultimate FC layer.Q

One of the challenges faced was that the dataset was severely imbalanced in nature. It is a difficult problem to try and balance the dataset with equal number of samples for each discretized value that each of the 51 individual classes can take.

It was then queried whether it is better to choose a ‘balanced’ dataset or a ‘representative’ dataset. Since our use case was prediction of action unit intensity, it made more sense to try and balance the data so that the minority classes or values are over-sampled. This was challenging to do since adding data points to one bin capsized other bins. Some of the experiments we tried to compensate for the imbalance were as follows:
1. Each sample in the dataset was given a ‘likeability’ score based on the mean of Top-K activations.
2. Each class in the dataset was given a weight based on

$$exp ( 1 - \frac{{a}_{c}}{{\sum }_{c} {a}_{c}} )$$

where a_c is the number of activations for a particular class.

The dataset was attempted to be balanced using a heuristic algorithm. There are 561 classes if we consider the multi-class multi-valued problem as a larger multi-class problem when the continuous values are rounded off and discretized. First, consider each class as a bin. Then sample data points with replacement from the dataset to add to each of these bins. Next, impose a specific order with the rarest value-class pair in the beginning and the most commonly found value-class pair in the end. Then, start sampling datapoints from the original dataset to fill the first bin with N number of points. This affects the rest of the bins and the more commonly occurring value-class pair bins start filling up. Then, move to the next bin. The second bin may have M number of data points filled up already due to the activity in the first bin. Now add up the remaining M-N number of points. If M>N, do not add or remove any points and move on to the next bin.

Performance Evaluation Measures

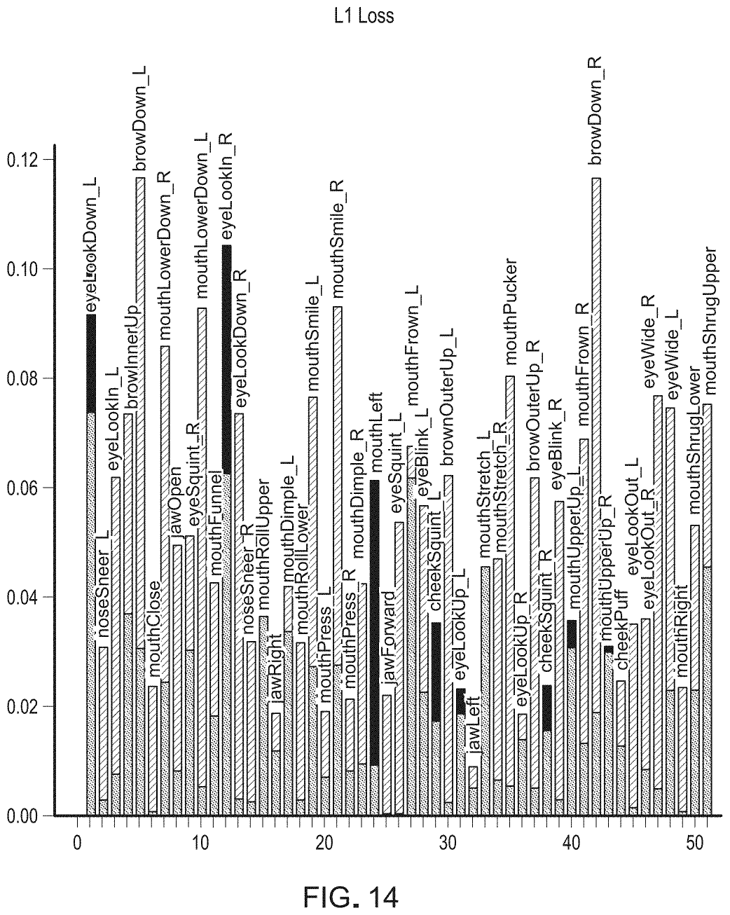

The training and validation loss continue to decrease through the course of 50 epochs for each experiment. The lowest training errors approach e-05. The validation score is a random sample of the training data and does not give a useful signal for over-fitting. We split the training and testing data by different people. In this case, the test data contained 2 entire questionnaires (˜150,000 data points) collected from videos of two unseen people. On comparison of scores on the testing data, we conclude that the second method works slightly better than the rest. All the results below apply to the same method. As is shown in FIG. 14, the average L1 loss on the test set is 0.049 and the L2 loss is 0.0116. As is further shown in FIG. 14, L1 Loss by Action Units are displayed with black bars displaying the average L1 loss for each action unit. FIG. 14 shows considerable variability. The crosshatched bars are normalized to show the number of activations for that action unit present in the training distribution. It should be noted that the range of the average L1 loss goes from ˜0.0 to ˜0.1.

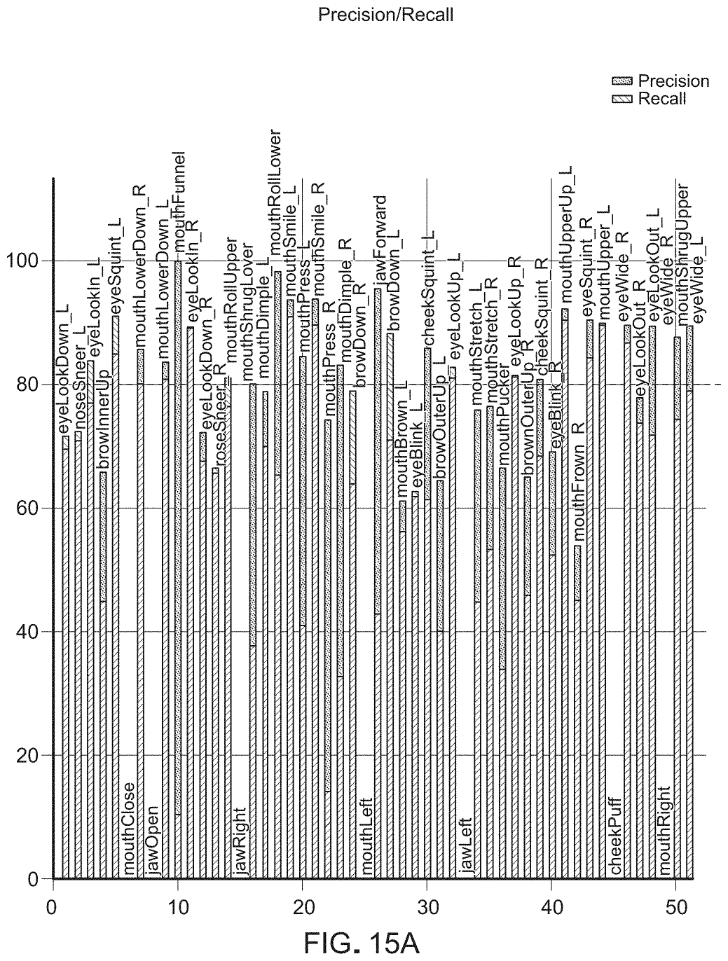

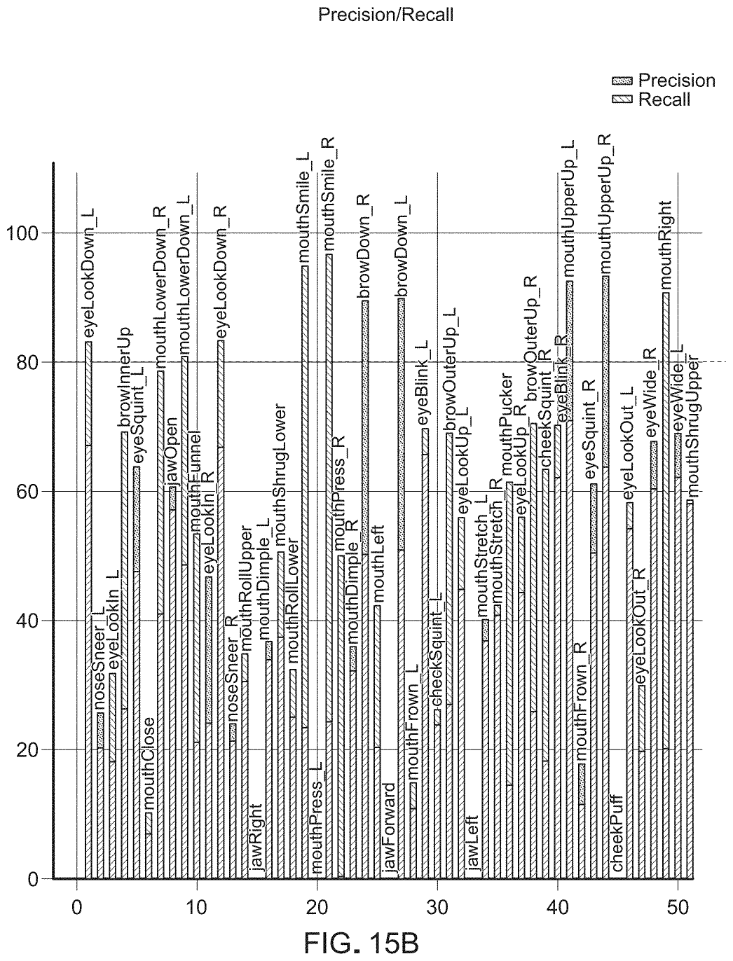

Next, precision-recall for each of the action units is explored, making reference to FIG. 15. As is shown, there are far fewer action units with precision and recall over the 80% line in the test set for phase 2 as opposed to phase 1. For cases where the precision is high and the recall is low (since there is a significant difference between both scores for some action units), it implies that the network under-estimates the value of these action units and does not activate reliably on them. For cases where the recall is high but the precision is low, one can conclude that the network over-estimates the values for these action units leading to many false positives in activations. Unlike the graph in phase 1, we cannot conclude any action unit to be showing both, good (above the 80% mark) precision as well as recall in phase 2.

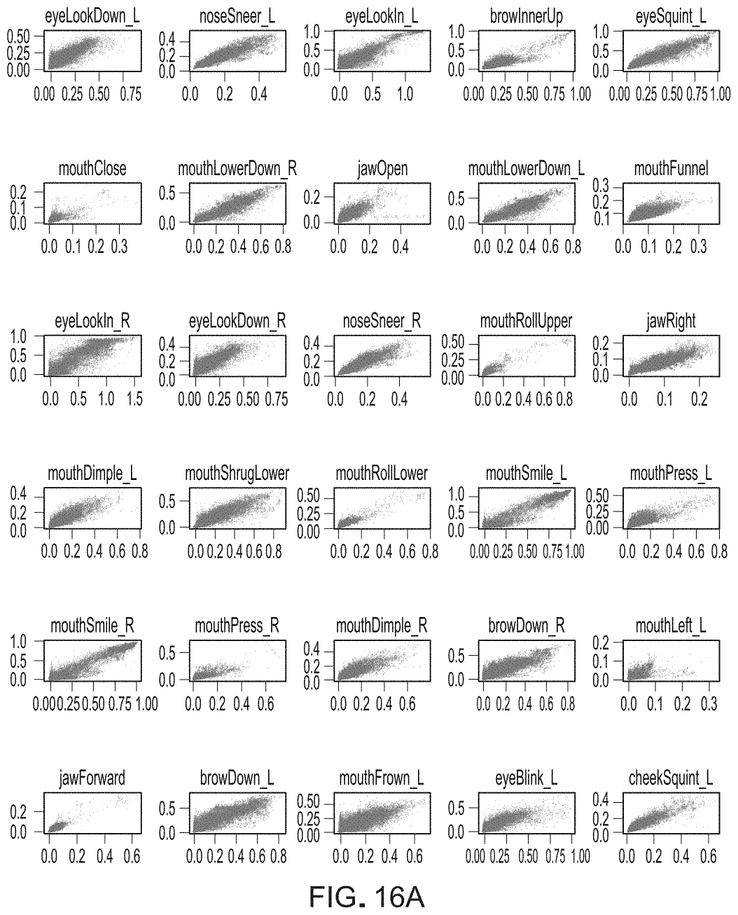

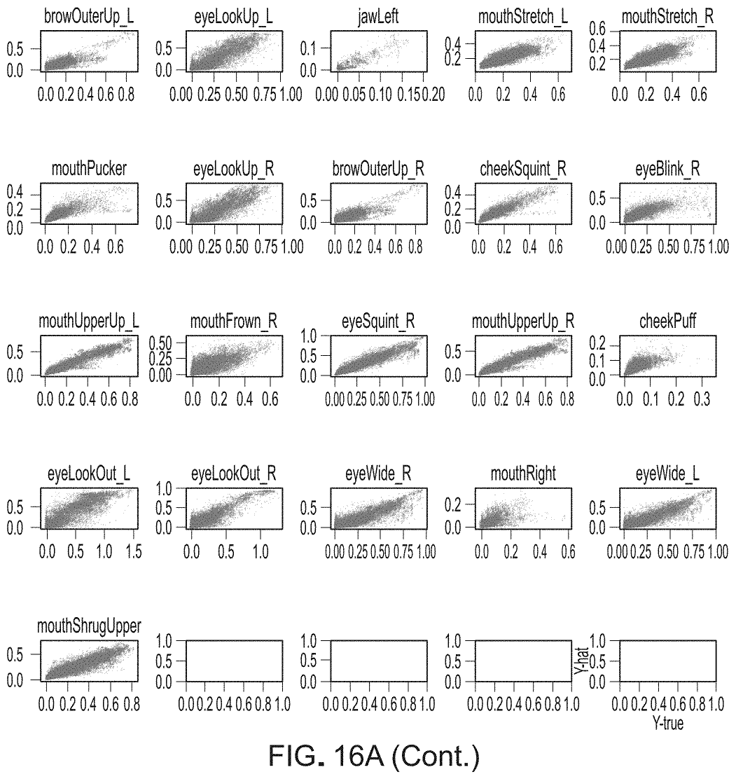

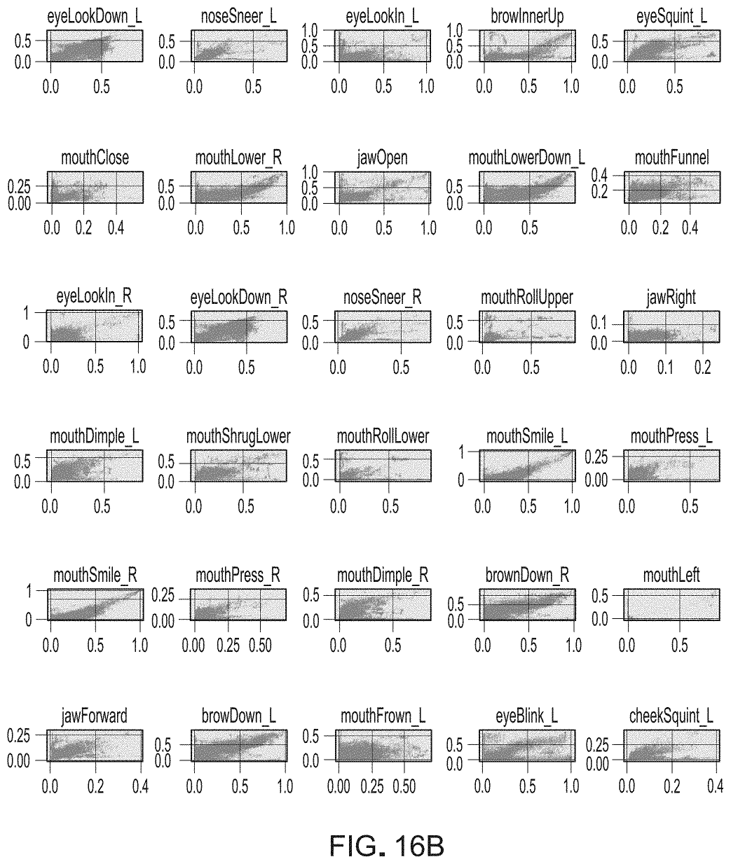

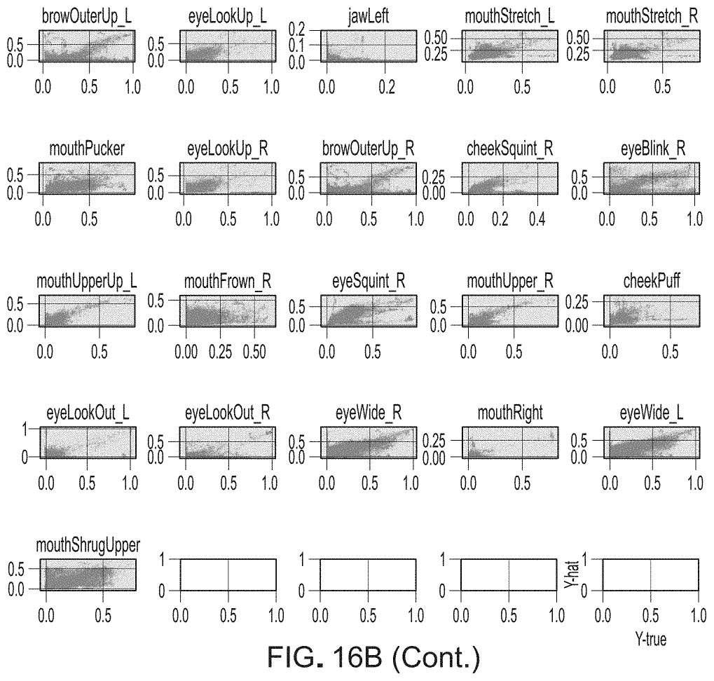

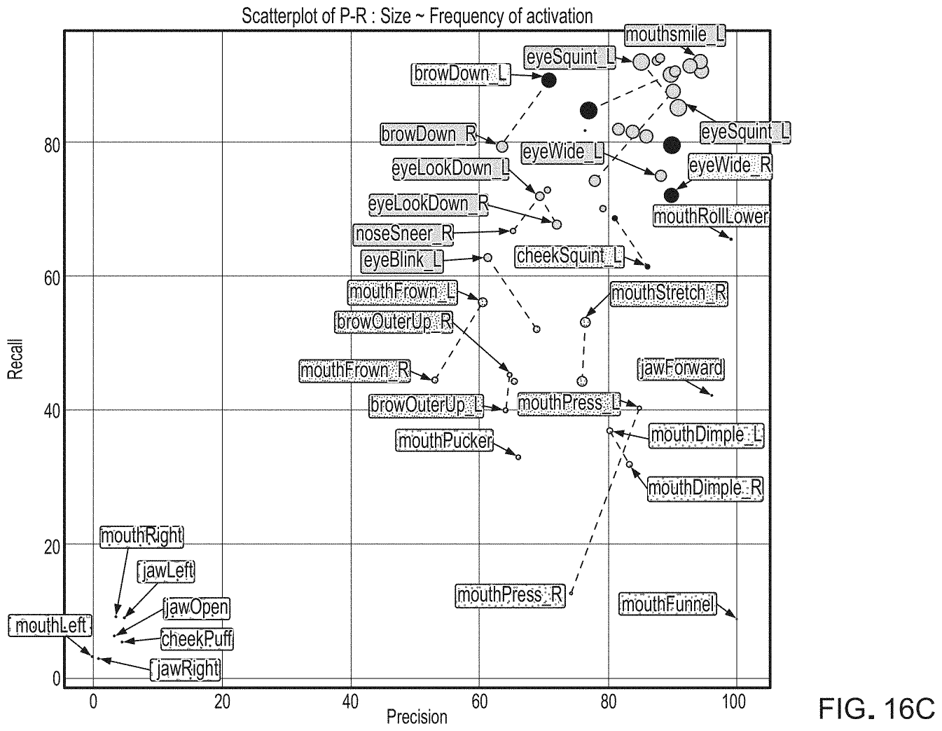

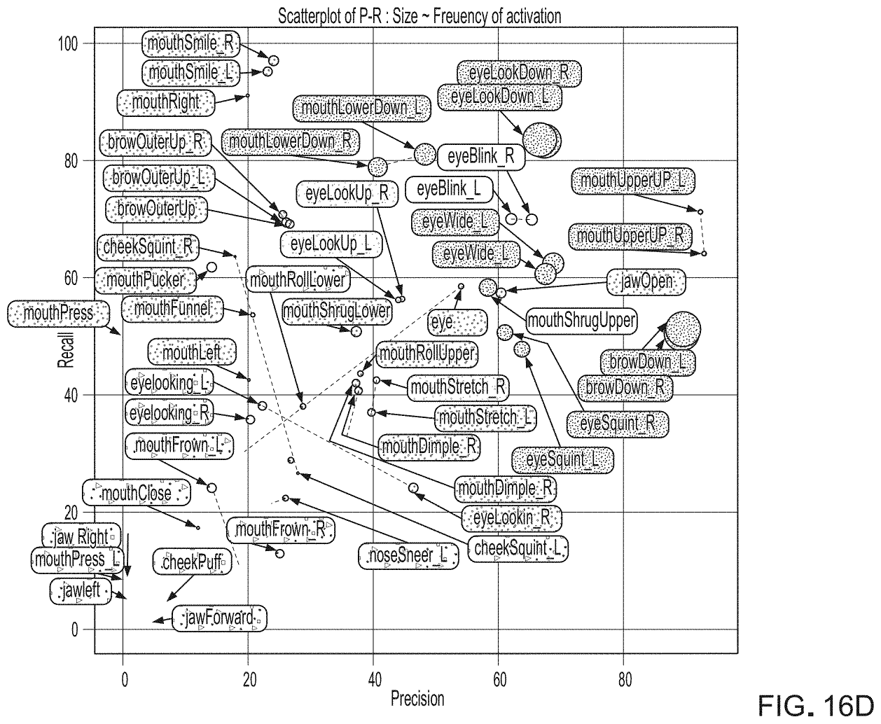

Looking at one more set of graphs for results on the test dataset as set forth on FIG. 16, the scatter plot for each action unit shows the general trend between the true distribution and the predicted distribution. For each of the graphs, the x-axis corresponds to the true value of the data points while the y-axis corresponds to the predicted value of the data points.

There is a noticeable difference between the two phases. In the first phase (FIG. 16A), the pattern between the correct and predicted values is closing in on narrow and linear. It is much more chaotic for Phase 2 (FIG. 16B). Notice that for some action units such as ‘mouthLowerDown_L’ and ‘mouthLowerDown_R’, the curve tends to have a convex shape showing that the network under-estimates when predicting higher values. It is noted that action units such as ‘mouthShrugUpper’ have a rectangular block-like structure showing that the network perhaps was not quite able to pick up on a pattern there.

The final graphs (FIGS. 16C and 16D) show a scatter plot of the precision-recall values with the size of the marker proportional to the amount of activations in the training data available for a particular action unit.

Some other interesting techniques to interpret a network were explored such as occluding parts of the image to zone down on which areas of a face the network looks at for predicting a particular action unit. This provided useful insights on how to debug the network.

Another method explored was optimizing an image initialized with random noise with the objective to activate a neuron in the final fully connected layer (or any other layer for that matter) in the network. This led to some very interesting conclusions.

### Facial Expressiveness Scores

The Facial Expressiveness Score may be defined as a non-negative measure assigned to a face. The score is higher the more ‘expressive’ the face is. Defining expressivity is not straightforward since interpretation of expressions and expressiveness is subjective. Here two options for defining a score were introduced:
1. Based on human annotation.
2. Based on a statistical measure of deviation from the normal or common “rest expression”.

This definition substitutes the probability of observing a face configuration as a proxy for expressivity.

Moreover, expressions and expressivity can vary widely between different individuals. Therefore, an absolute (or generic) expressivity score was also defined in which a single scale was used for the whole population as well as personalized expressivity scores which are used to measure expressivity in an individual subject.

Models for expressivity can be classified as supervised or unsupervised corresponding to the definitions above of expressivity using human annotation or based on probability of a face configuration. The models can then be further classified as personalized or generic depending on whether they try to capture assign a single score to the whole population or to an individual. Below two models for unsupervised modeling of expressivity are described.

Action units make intuitive sense as features for capturing expressivity. An unsupervised method used in a preferred implementation is to independently fit univariate gaussians to a set of n action unit activations of interest {fᵢ}ᵢ₌₁ⁿ. The expressivity score can then be defined as:

$$e = \frac{1}{k} {\sum }_{j = 1}^{k} {s}_{{i}_{j}}$$

$$where$$

$${s}_{i} = \frac{{( {f}_{i} - {μ}_{i} )}^{2}}{{σ}_{i}^{2}} and {s}_{{i}_{1}} >= {s}_{{i}_{2}} >= … >= {s}_{{i}_{n}} ,$$

for some parameter k.

Another unsupervised approach relies on configurations of facial keypoints or landmarks indicative of movement of one or more portions of the face of an individual indicative of emotion. The idea is that the non-rigid deformation from a “rest configuration” captures the degree of expressiveness. Here Gaussians can be fit to distances between keypoints and a center (or centroid).

The advantage of using distances from a center is that one can eliminate (in 3D) or approximately eliminate (in 2D) the rigid part of a deformation of a configuration of keypoints relative to the “rest configuration”. For a given configuration of (68 in this example) facial keypoints P={pᵢ}ᵢ₌₁⁶⁸ a center can be defined as c(P)=c_{P} The center can be computed in various ways. In one preferred implementation, it is computed as the center point between a horizontal line drawn through the eyes, since the eyes do not deform horizontally.

In a Gaussian with parameters i, i is fitted to observed distances dᵢ=∥c_{P}−pᵢ∥ in a training set. A score associated with keypoint I may be defined as

$${s}_{i} = \frac{{( {d}_{i} - {μ}_{i} )}^{2}}{{σ}_{i}^{2}} .$$

The expressivity score is thus given as the mean of the top k keypoint scores possibly excluding keypoints on the silhouette of the face.

Objectifying “facial expressivity” is a challenging problem. In yet another implementation of an expressivity score, Gaussian kernel density estimation was employed to calculate the probability of a value being taken by an action unit. This probability was calculated based on the entire population. Then the “expressivity” was inversely scored based on this probability. This allowed comparison of facial expressivity among all the people that participated in the data collection in phase 2 as well as look at the progression of expressivity over the course of the questionnaire for one person. This is potentially useful signal to identify which parts of the questionnaire operate as more evocative stimuli from people versus others that do not.

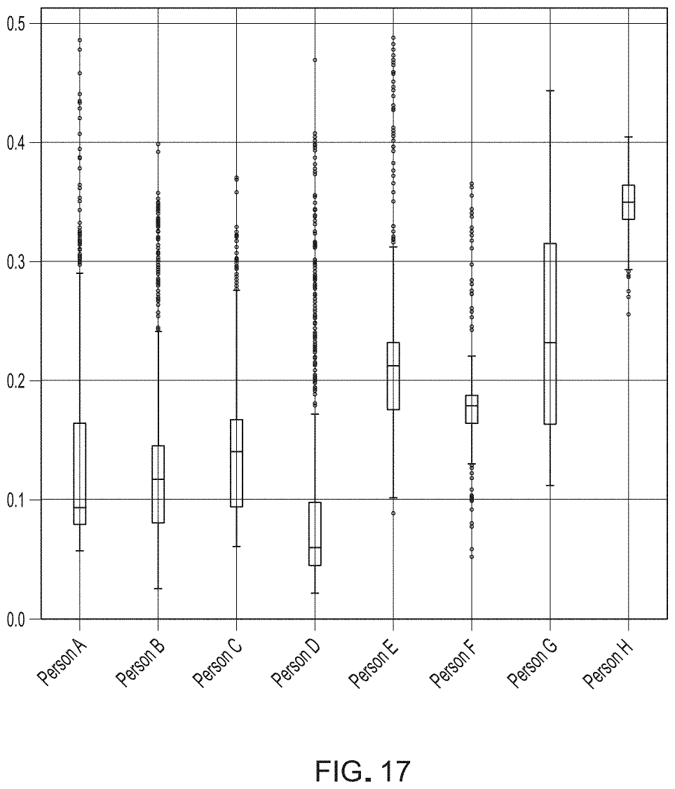

Next, the expressivity scores for each person's neutral face was plotted based on the above algorithm. It turns out (as shown in FIG. 17), each person started out with a rather different expressivity score. Generally, FIG. 17 depicts Expressivity Scores for the “rest face” for different people. These expressivity scores from the neutral faces were used to re-calibrate our scores for the other videos for each individual data subject, thus providing a comparative baseline for each such subject. This led to better results.

In particular, the plot shown in FIG. 17 is a box-and-whisker or commonly called, boxplot. In the plot, the x-axis is different individuals. Each box therefore corresponds to a different individual. The expressivity range for the rest face for different individually substantially varies. The box shows the quartiles of the data for one individual in the video where they were asked to keep their face neutral. The whiskers extend to show the rest of the distribution, the points at the end of the whiskers show the “outliers”. The orange line/notch on each box represents the median. This is the value used as the rest face expressivity score.

All or part of the processes described herein and their various modifications (hereinafter referred to as “the processes”) can be implemented, at least in part, via a computer program product, i.e., a computer program tangibly embodied in one or more tangible, physical hardware storage devices that are computer and/or machine-readable storage devices for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Actions associated with implementing the processes can be performed by one or more programmable processors executing one or more computer programs to perform the functions of the calibration process. All or part of the processes can be implemented as, special purpose logic circuitry, e.g., an FPGA (field programmable gate array) and/or an ASIC (application-specific integrated circuit). Other embedded systems may be employed, such as NVidia® Jetson series or the like.

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer (including a server) include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, e.g., magnetic, magneto-optical disks, or optical disks. Processors “configured” to perform one or more of the processes, algorithms, functions, and/or steps disclosed herein include one or more general or special purpose processors as described herein as well as one or more computer and/or machine-readable storage devices on which computer programs for performing the processes are stored.

Tangible, physical hardware storage devices that are suitable for embodying computer program instructions and data include all forms of non-volatile storage, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks and volatile computer memory, e.g., RAM such as static and dynamic RAM, as well as erasable memory, e.g., flash memory.

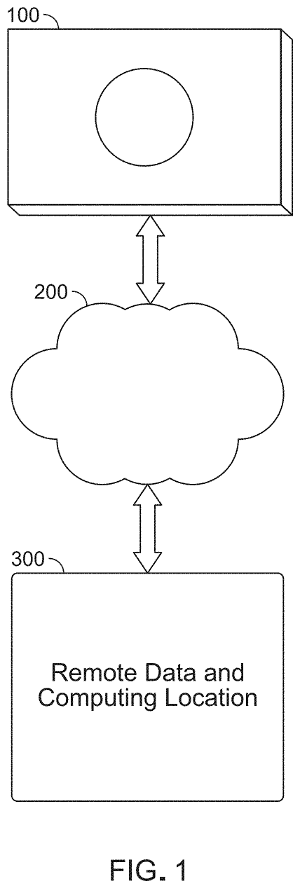

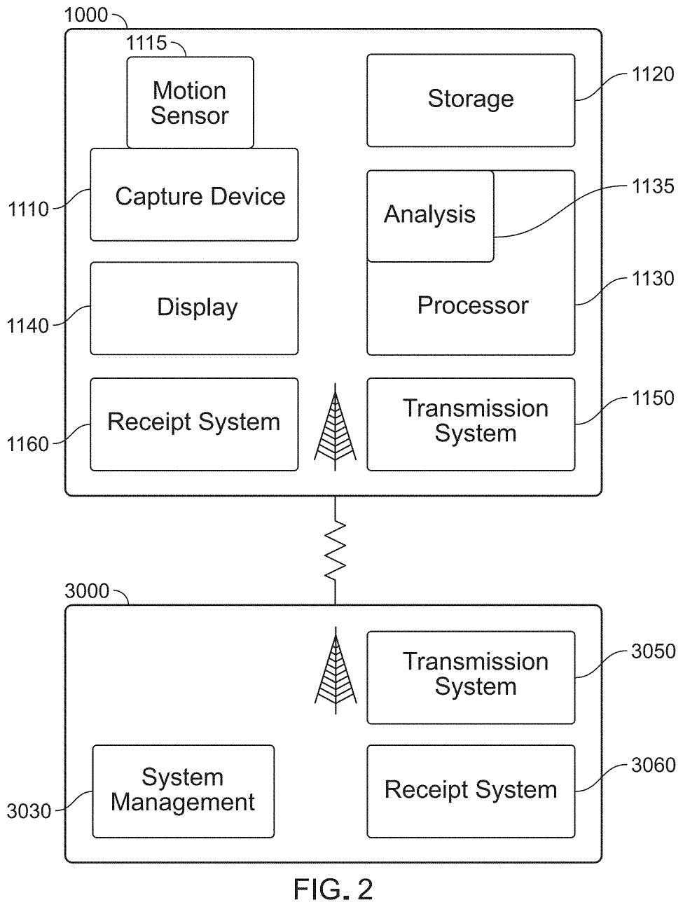

Systems such as those shown in FIGS. 1 and 2 may also be employed to implement the embodiments of the subject matter described in this specification. Referring to FIG. 1, a data capture and transfer system constructed in accordance with an embodiment of the disclosure is shown. In FIG. 1, a remote information capture apparatus 100 is shown. Such apparatus is adapted to allow for the capture and processing of information in order to implement the system and method in accordance with the present disclosure, such as capturing one or more images of a patient administering medication, responding to presentation of one or more images or other stimuli to the patient, or conducting an adaptive, simulated interview with the patient. Such information capture apparatus 100 is placed in communication with a remote data and computing location 300 via a communication system 200 such as the Internet or other communication system. Via communication system 200, information captured by apparatus 100 may be transmitted to remote data and computing location 300, and analysis information or other instructions may be provided from remote data and computing location 300 to apparatus 100. It is further contemplated that a plurality of such information capture apparatuses 100 may be coordinated to monitor a larger space than a space that can be covered by a single such apparatus. Thus, the apparatuses can be made aware of the presence of the other apparatuses, and may operate by transmitting all information to one of the apparatuses 100, or these apparatuses may each independently communicate with remote data and computing location, which is adapted to piece together the various information received from the plurality of devices 100. Remote system 300 may also comprise a data storage repository, or may be omitted, so that all processing is performed on capture apparatus 100.

The system may additionally process information at remote system 300 housing a database of collected information. New images, video, audio, or data associated with another associated sensor acquired by an image acquisition camera 1110 (see FIG. 2) in local mobile device 100 may be transmitted to the remote location 300, one or more of the above-noted identification or processing techniques may be applied, and then the results of such analysis may be provided as feedback to a user or other healthcare provider to provide feedback to the user via device 100, or through another predefined communication method, such as by a registered mobile device number, text message, or other available communication system, to confirm that a medication presented to the system is a proper or improper medication.

Referring next to FIG. 2, a more detailed view of a preferred embodiment of remote information capture apparatus 1000 (as an example of apparatus 100) and remote data and computing location 3000 (as an example of location 300). As is shown in FIG. 2, apparatus 1000 comprises an information capture device 1110 for capturing video and audio data as desired. A motion detector 1115 or other appropriate trigger device may be provided (or may be omitted) associated with capture device 1110 to allow for the initiation and completion of data capture. Information capture device 1110 may comprise a visual data capture device, such as a visual camera, or may be provided with an infrared, night vision, ultrasonic, laser, 2D, 3D, distance camera, radar or other appropriate information capture device, and all may be use alone on in any desired combination. A storage location 1120 is further provided for storing captured information, and a processor 1130 is provided to control such capture and storage, as well as other functions associated with the operation of remote information capture apparatus 1000. An analysis module 1135 is provided in accordance with processor 1130 to perform a portion of analysis of any captured information at the remote information capture apparatus 1000. For example, the analysis module may include the estimator H and estimator L of FIGS. 3-7. The analysis module may further include a training engine that is configured to train the estimator H and estimator L using an unsupervised or supervised learning technique. For example, the training engine is configured to adjust current values of parameters of the estimator L to minimize a loss that represents a difference in quality between an estimate generated by the estimator H and an estimate generate by the estimate L. In some implementations, the training engine may jointly adjust the current values of parameters of both the estimator H and estimator L during training. Apparatus 1000 is further provided with a display 1140, and a data transmission and receipt system 1150 and 1160 for displaying information, and for communicating with remote data and computing location 3000. Remote data and computing location 3000 comprises system management functions 3030, and a transmission and reception system 3050 and 3060 for communicating with apparatus 1000. Transmission and reception system 3050 and 3060 may further comprise various GPS modules so that a location of the device can be determined at any time, and may further allow for a message to be sent to one or more individual apparatuses, broadcast to all apparatuses in a particular trial, or being used for administration of a particular prescription regimen, of broadcast to all available apparatuses. Of course, computing location also comprises computing and processing system hardware, such as that described related to apparatus 1000, including at least a processor and analysis module, and a display, if appropriate.

In accordance with an embodiment of the disclosure, apparatus 1000 is adapted to be part of a system that monitors progression of symptoms of a patient in a number of ways, and may be employed during use of a medication adherence monitoring system relying on visual, audio, and other real time or recorded data. Users of apparatus 1000 in accordance with this are monitored in accordance with their interaction with the system, and in particular during medication administration or performance of some other common, consistent activity, in response to presentation of visual material to the patient, or during the conduct of an adaptive, automated interview with the patient. Apparatus 1000 of the disclosure is adapted to receive instructions for patients from remote data and computing location 3000 and provide these instructions to patients. Such instructions may comprise written, audio or audio instructions for guiding a user to perform one or more activities, such as determining whether a user is adhering to a prescribed medication protocol by presenting a correct medication to the system, instructions and visual images to be provided to the patient so that a response may be measured, or instructions that are adaptive in order to allow for the conduct of an adaptive, automated interview with the patient.

In addition, the logic flows depicted in the figures do not require the particular order shown, or sequential order, to achieve desirable results. In addition, other actions may be provided, or actions may be eliminated, from the described flows, and other components may be added to, or removed from, the described systems. Likewise, actions depicted in the figures may be performed by different entities or consolidated. Furthermore, various separate elements may be combined into one or more individual elements to perform the functions described herein.

While visual and audio signals are mainly described in this disclosure, other data collection techniques may be employed, such as thermal cues or other wavelength analysis of the face or other portions of the body of the user. These alternative data collection techniques may, for example, reveal underlying emotion/response of the patient, such as changes in blood flow, etc. Additionally, visual depth signal measurements may allow for capture subtle facial surface movement correlated with the symptom that may be difficult to detect with typical color images.

Other implementations not specifically described herein are also within the scope of the following claims.

It should be noted that any of the above-noted embodiments may be provided in combination or individually. Elements of different embodiments described herein may be combined to form other embodiments not specifically set forth above. Elements may be left out of the processes, computer programs, etc. described herein without adversely affecting their operation. Furthermore, the system may be employed in mobile devices, computing devices, cloud based storage and processing. Camera images may be acquired by an associated camera, or an independent camera situated at a remote location. Processing may be similarly be provided locally on a mobile device, or a remotely at a cloud-based location, or other remote location. Additionally, such processing and storage locations may be situated at a similar location, or at remote locations.

What is claimed is:

1. A system comprising one or more computers and one or more storage devices storing instructions that, when executed by the one or more computers, cause the one or more computers to perform operations comprising:
performing the following steps at least once:
receiving rich sensor data, captured by a high-resolution sensor, of an input scene;
receiving limited sensor data, captured by a low-resolution sensor, of the input scene;
processing the rich sensor data using a first estimator to generate a first estimate that represents a first set of characteristics of the input scene;
processing the limited sensor data using a second estimator to generate a second estimate in accordance with current values of parameters of the second estimator, the second estimate representing a second set of characteristics of the input scene, the second estimator being a deep neural network;
determining a loss function that represents a difference in quality between the first estimate and the second estimate; and
training the second estimator by adjusting the current values of the parameters of the second estimator to minimize the loss function; and
obtaining new limited sensor data, captured by the low-resolution sensor, of a new input scene; and
processing the new limited sensor data using the trained second estimator in accordance with the adjusted values of parameters of the second estimator to generate a new estimate that represents a new set of characteristics of the new input scene.

2. The system of claim 1, wherein the operations comprise: repeatedly performing the steps to adjust the current values of parameters of the second estimator until the loss function is less than a predetermined threshold.

3. The system of claim 1, wherein the rich sensor data includes high-resolution RGB images of the input scene and corresponding depth maps of the high-resolution RGB images.

4. The system of claim 1, wherein the limited sensor data includes low-resolution RGB images of the input scene.

5. The system of claim 1, wherein the low-resolution sensor is a camera of a portable device.

6. The system of claim 1, wherein the deep neural network comprises one or more convolutional neural network layers followed by one or more fully connected neural network layers followed by a sigmoid activation neural network layer.

7. The system of claim 1, wherein the input scene is a face of a user.

8. The system of claim 7, wherein the first estimate and the second estimate comprise estimated facial action units of the user's face, wherein a facial action unit represents an action of one or more muscles of the user's face and identifies a facial expression of the user.

9. The system of claim 7, wherein the first estimate and the second estimate comprise estimated blendshapes of the user's face.

10. A computer-implemented method comprising:
performing the following steps at least once:
receiving rich sensor data, captured by a high-resolution sensor, of an input scene;
receiving limited sensor data, captured by a low-resolution sensor, of the input scene;
processing the rich sensor data using a first estimator to generate a first estimate that represents a first set of characteristics of the input scene;
processing the limited sensor data using a second estimator to generate a second estimate in accordance with current values of parameters of the second estimator, the second estimate representing a second set of characteristics of the input scene, the second estimator being a deep neural network;
determining a loss function that represents a difference in quality between the first estimate and the second estimate; and
training the second estimator by adjusting the current values of the parameters of the second estimator to minimize the loss function; and
obtaining new limited sensor data, captured by the low-resolution sensor, of a new input scene; and
processing the new limited sensor data using the trained second estimator in accordance with the adjusted values of parameters of the second estimator to generate a new estimate that represents a new set of characteristics of the new input scene.

11. The method of claim 10, further comprising: repeatedly performing the steps to adjust the current values of parameters of the second estimator until the loss function is less than a predetermined threshold.

12. The method of claim 10, wherein the input scene is a face of a user.

13. The method of claim 12, wherein the first estimate and the second estimate comprise estimated facial action units of the user's face, wherein a facial action unit represents an action of one or more muscles of the user's face and identifies a facial expression of the user.

14. The method of claim 12, wherein the first estimate and the second estimate comprise estimated blendshapes of the user's face.

15. One or more non-transitory computer storage media encoded with instructions that, when executed by one or more computers, cause the one or more computers to perform operations comprising:
performing the following steps at least once:
receiving rich sensor data, captured by a high-resolution sensor, of an input scene;
receiving limited sensor data, captured by a low-resolution sensor, of the input scene;
processing the rich sensor data using a first estimator to generate a first estimate that represents a first set of characteristics of the input scene;
processing the limited sensor data using a second estimator to generate a second estimate in accordance with current values of parameters of the second estimator, the second estimate representing a second set of characteristics of the input scene, the second estimator being a deep neural network;
determining a loss function that represents a difference in quality between the first estimate and the second estimate; and
training the second estimator by adjusting the current values of the parameters of the second estimator to minimize the loss function; and
obtaining new limited sensor data, captured by the low-resolution sensor, of a new input scene; and
processing the new limited sensor data using the trained second estimator in accordance with the adjusted values of parameters of the second estimator to generate a new estimate that represents a new set of characteristics of the new input scene.

16. The one or more non-transitory computer storage media of claim 15, wherein the operations further comprise: repeatedly performing the steps to adjust the current values of parameters of the second estimator until the loss is less than a predetermined threshold.

17. The one or more non-transitory computer storage media of claim 15, wherein the rich sensor data includes high-resolution RGB images of the input scene and corresponding depth maps of the high-resolution RGB images.

18. The one or more non-transitory computer storage media of claim 15, wherein the limited sensor data includes low-resolution RGB images of the input scene.

19. The one or more non-transitory computer storage media of claim 15, wherein the input scene is a face of a user, and wherein the first estimate and the second estimate comprise estimated facial action units of the user's face, wherein a facial action unit represents an action of one or more muscles of the user's face and identifies a facial expression of the user.

20. A computer-implemented method comprising:
performing, using one or more computers of a first system, the following steps at least once:
receiving rich sensor data, captured by a high-resolution sensor, of an input scene;
receiving limited sensor data, captured by a low-resolution sensor, of the input scene;
processing the rich sensor data using a first estimator to generate a first estimate that represents a first set of characteristics of the input scene;
processing the limited sensor data using a second estimator to generate a second estimate in accordance with current values of parameters of the second estimator, the second estimate representing a second set of characteristics of the input scene, the second estimator being a deep neural network;
determining a loss function that represents a difference in quality between the first estimate and the second estimate; and
training the second estimator by adjusting the current values of the parameters of the second estimator to minimize the loss function; and
providing the trained second estimator to a second system for processing new limited sensor data using the trained second estimator to generate a new estimate.
